(19) United States
(12) Patent Application Publication
(10) Pub. No.: US 2016/0110696 A1
(43) Pub. Date: Apr. 21, 2016

(54) BOTTOM OF THE PYRAMID PAY METHOD AND SYSTEM

(71) Applicant: MasterCard International Incorporated, Purchase, NY (US)

(72) Inventors: Michael David Angus, Ridgewood, NJ (US); John Beric, London (GB); David Colby Brown, Dardenne Prairie, MO (US); Chanoch Henuch Gewirtz, Passaic, NJ (US); Salah Malaika Goss, New York, NY (US); Dennis J. Hill, St. Paul, MO (US); Patrick L. Killian, Cottleville, MO (US); Sandeep Malhotra, Stamford, CT (US); Paul Michael Musser, Pilot Hill, CA (US); Tara Nathan, Brooklyn, NY (US); David Anthony Roberts, Warrington (GB); Mark N. Savoye, Hartsdale, NY (US); Dave Sylvester, Essex (GB)

(21) Appl. No.: 14/884,151

(22) Filed: Oct. 15, 2015

Related U.S. Application Data
(60) Provisional application No. 62/064,063, filed on Oct. 15, 2014.

(51) Int. Cl. G06Q 20/10; G06Q 20/36

(52) U.S. Cl. CPC G06Q 20/108; G06Q 20/367

(57) ABSTRACT

One or more embodiments provide a system and method comprising receiving at a device a first token associated with a first account; executing a transaction; recording the executed transaction at each of the device and the first token, wherein the execution of the transaction is offline; and balancing the account associated with the first token per the transaction when the first token is online after the executed transaction. Numerous other aspects are provided.

### CROSS REFERENCE TO RELATED APPLICATION

The present application claims priority from the following U.S. Provisional Patent Application, which is hereby incorporated by reference herein in its entirety for all purposes:

U.S. Provisional Patent Application Ser. No. 62/064,063, filed Oct. 15, 2014, and entitled “Bottom of the Pyramid Pay Method and System” (Attorney Docket No. P01901-US-PROV (M01.333P)).

### BACKGROUND

The use of credit card, debit cards, stored values cards, and other means of payment relying on payment account numbers (PANs), as opposed to cash, is ever-increasing among consumers. However, a large portion of the adult population still relies on cash, and may pay almost exclusively in cash at micro/small merchants or at larger merchants, especially in developing countries. These consumers may have unsteady income that may come in tranches (e.g., receiving pay following harvests), and may make dozens of small transactions weekly. These people may be both consumers and merchants, mixing their resources. While these consumers are often not associated with a formal banking institution (“unbanked”), they may participate in informal borrowing and saving. As these consumers are unbanked, they may spend an extraordinary amount of time tracking their money and “making ends meet.”

The unbanked consumers may live in rural communities and on the outskirts of a major city; they may have a mobile account but may not always own a phone. While the unbanked consumers may use the mobile account, use of mobile accounts is low and may mainly consist of person to person (P2P) transactions (e.g., they use it only for sending money to people). Additionally, the unbanked consumers may experience unreliable telecommunications and power every day.

The present inventors have now realized that it may be desirable to provide efficient monetary transaction delivery, storage and tracking to the unbanked.

### SUMMARY OF THE INVENTION

In certain aspects of the invention, a method is provided. The method includes receiving at a device a first token associated with a first account; executing a transaction; recording the executed transaction at each of the device and the first token, wherein the execution of the transaction is offline; and balancing the account associated with the first token per the transaction when the first token is online after the executed transaction.

In another aspect of the invention, a system is provided. The system includes a first token associated with a first account; a device operative to receive the first token; wherein a transaction between the first token and the device is executed and then recorded on each of the first token and the device; a memory; at least one bottom of pyramid pay processor, coupled to the memory, and operative to: receive the transaction information, and balance the account associated with the first token per the transaction when the first token is online after the executed transaction.

Other features and aspects of the present invention will become more fully apparent from the following detailed description, the appended claims and the accompanying drawing.

### BRIEF DESCRIPTION OF THE DRAWINGS

FIG. 1 is a flow diagram illustrating a process that may be performed in accordance with aspects of some embodiments herein;

FIG. 2 is a schematic block diagram representation of a system, in accord with some aspects of some embodiments herein;

FIG. 3 is a schematic block diagram representation of a system, in accord with some aspects of some embodiments herein;

FIG. 4 is a flow diagram illustrating a process that may be performed in accordance with aspects of some embodiments herein;

FIGS. 5A and 5B illustrate a device, in accordance with some embodiments;

FIG. 6 is a flow diagram illustrating a process that may be performed in accordance with aspects of some embodiments herein;

FIG. 7 illustrates a device, in accordance with some embodiments;

FIG. 8 is a block diagram of a system, in accordance with some embodiments;

FIG. 9 is a block diagram of a Base of Pyramid (BoP) Pay processing tool or platform according to some embodiments;

FIG. 10 is another block diagram of a BoP Pay processing tool or platform according to some embodiments;

FIG. 11 is a block diagram of a BoP Pay processing tool or platform according to some embodiments; and

FIG. 12 is a schematic diagram of a system, in accordance with some embodiments.

### DETAILED DESCRIPTION

Despite the increasing use among consumers of credit cards, debit cards, stored values cards, and other means of payment, a large portion of the adult population still relies on cash, and may pay almost exclusively in cash at micro/small merchants or at larger merchants, especially in developing countries. These consumers may have unsteady income that may come in tranches (e.g., receiving pay following harvests), and may make dozens of small transactions weekly. These people may be both consumers and merchants, mixing their resources. While these consumers are often not associated with a formal banking institution (“unbanked”), they may participate in informal borrowing and saving. Unbanked consumers may spend an extraordinary amount of time tracking their money and “making ends meet.”

Traditional debit and credit cards may not meet the needs of unbanked consumers, payers and the ecosystem in which they operate. For example, although not provided by traditional debit and credit cards, it may be desirable to:

ensure an originator of a transaction can have absolute confidence that their funds cannot move without their permission, and that the intended recipient has received those funds;

ensure that funds moving in a transaction are “good funds” (e.g., funds represent money on deposit and are not exposed to potentially other calls or limitations);

ensure both the originator of the transaction and the recipient of the funds are confident that upon the completion of the transaction, no reversal of the transaction is permitted;

have anyone be a merchant immediately with no risk management documentation;

have no need for a bank or other fiduciary to assume acquiring risk; as funds are exchanged in near-to-actual real time, there is no reversal of transaction and all funds are good funds;

have no need for issuers (e.g., in a historical context of a fiduciary that takes on the risk of enabling a consumer with a purchase device, often associated to a broader account relationship with the fiduciary) as the consumer may only be able to use good funds in near/real time and without repudiation;

have a buyer of goods and services be also a seller of goods and services on another occasion (e.g., no additional documentation is needed to occupy both roles);

have a pricing model that supports nearly exclusive small value payments and frequent non-payment transactions; and

a business model that is flexible and not predefined in its participation including potentially single and multi-party ownership of network and contribution of revenue (e.g., banks, Mobile Network Operator (MNO), Non-Governmental Organizations (NGOs)s, governments, consumer goods manufacturers/distributors, etc.).

There are further a number of significant differences between a solution optimized for embodiments of the Base of the Pyramid system described herein, and traditional credit, debit and prepaid payment systems. For example, participation in domestic-only transactions with likely local branding and on-soil operations requirements may be possible with debit cards, and not credit cards. Further, while it may be possible for traditional debit and credit cards to always work regardless of utility status (e.g., electricity or telecommunications), doing so may not be possible without tangibly increasing risk. The result is that traditional credit, debit or pre-paid cards do not meet all of the above-listed needs and therefore cannot effectively serve the Base of the Pyramid customer.

Additionally, governments, financial institutions and CGIs (collectively referred to herein as “Institutions”) may face other challenges to being more financially inclusive of the Base of the Pyramid customer. Other challenges may be, for example, the flexibility of the systems and platforms already in place (e.g., legacy platform) and costs in developing and updating the systems and platforms; the identification and authentication of citizens to receive funds from the Institutions, as well as the paperwork and time required to enroll the citizens; fraud and leakage of funds; lack of traditional acceptance locations and ATMs; and the time, cost and infrastructure required to move funds from one account holder to another (or to a merchant) when in close physical proximity.

One or more embodiments may provide a Base or Bottom of the Pyramid (BoP) Pay Value system and method (“BoP Pay”) to provide an accounting record of all monetary transactions, as well as to facilitate the transactions via a wallet module. One or more embodiments may provide an account that may be accessed with a card, for example, through a mobile wallet or mobile token, for example. The token may use chip technology that works off-line without requiring a mobile or internet connection. As used herein, the terms “card,” “token” and “mobile token” and “mobile wallet” may be used interchangeably, unless otherwise indicated. The account may be a basic deposit account with an ability to be interest-bearing. As used herein, the terms “consumer,” “customer,” “client,” and “user” may be used interchangeably unless otherwise indicated.

In some embodiments, BoP Pay provides a platform that may enable the offering of flexible solutions to the Institutions to address the challenges described above. In some embodiments, the platform may be offered to the Institutions in partnership with participating banks in their respective countries. In one or more embodiments BoP Pay may enable low cost branchless banking and transaction service delivery; improve control and efficiency for the Institutions; offer safe, secure, intuitive and convenient payments capability; reduce the cost and complexity of disbursements; achieve transparency via the elimination or decrease of fraud and “leakage;” reduce gray (informal) economy and increase tax base (e.g., because more people and more transactions); and help identify the correct citizen that qualifies for government programs.

In one or more embodiments, the account may be used with a mobile device and/or a card. In one or more embodiments, agents may enable transactions for the account utilizing a mobile device and/or a web interface. Transaction activity may be performed on a closed loop basis, separate from another card (e.g., MasterCard card) or PAN number is used to perform “off-us” transactions. As used herein, a “closed loop transaction” may be a transaction that happens within a given network that may not be interoperable with other networks. As used herein, an “off-us” transaction may be a transaction that occurs between two parties when each party belongs to a different network or bank.

In one or more embodiments, the card may be a biometric-enabled card (e.g., a card for which biometrics may be used for transaction authentication). In one or more embodiments, BoP Pay may provide devices enabling offline funds movement; devices enabling online to offline funds movement (and vice versa); devices enabling access to offline and/or online balances; bank operations; enrollment center operations; fraud management; 3D secure; data warehousing; SMS services; Ecommerce payment gateway.

In some embodiments, BoP Pay allows transactions without the traditional four-party model of a consumer, an issuer, a merchant and an acquirer, and instead includes simply the merchant, the consumer and a central fiduciary. Further, in some embodiments, a consumer card/token-holder may be a merchant and vice versa.

For example, a consumer may have an enabled token (e.g., card, mobile device, national id, etc.) upon which they load $25 using the BoP Pay solution. With this enabled token, the consumer may then go to another store and use the token to make a purchase, and/or the consumer may transfer at least some of the money to his sister's token across the country, the consumer may transfer at least some of the money to his utility holder's token/account to pay his bill, and/or a second consumer may transfer money to the first consumer's token. In one or more embodiments, the transactions may be recorded by the tokens, and the funds may be transferred in real-time, such that there is instantaneous good funds for the funds. In one or more embodiments, if a transaction occurs while there is no connectivity, once the token is used in a device (e.g., point of sale device) that is connected, the balance on the account ledgers is updated and the consumer has access to his/her transaction receipts. In one or more embodiments, if a transaction occurs while there is no connectivity (e.g., off-line), it happens with funds on the token and is like transacting in “cash.” Once the token is connected to the network, the real time balance may be viewed by the token holder. In one or more embodiments, a record of a transaction for cash, not via the token, may be stored in the system.

In one or more embodiments, good funds are stored on the “token,” which may, for example, be an EMV smart card. As used herein, “token” and “card” are used interchangeably.

In one or more embodiments, a merchant may have only a token and a transfer device, and funds may be moved in real-time between the merchant's token and the consumer's token.

In one or more embodiments, a merchant may have a device that has storage capacity but is not a token (e.g., a computer). The transaction may result in funds being removed from the consumer token and transferred to the merchant's device, but the merchant may not make use of those funds until they are reported to the central fiduciary and the fiduciary credits the seller's account.

In one or more embodiments, if connectivity is available, the merchant's device may, in real time, report the withdrawal of funds from the consumer's token and receive credit from the fiduciary immediately.

In one or more embodiments, receipts may be provided uniformly (e.g., receipts may be provided even when the payment is made in analog (paper) format). The uniformity of receipting may enable a consumer to use the token at every purchase. In one or more embodiments, the use of the token at every purchase may enable a consumer and merchants to be rewarded for use, and may provide insight into the cash and electronic transaction behaviors of consumers and merchants.

As used herein, a “mobile token” is a device which communicates using an out-of-band channel to demonstrate participation in BoP Pay electronically. In one or more embodiments, enrollment may be immediate and may not require a banking relationship. For example, the account may be opened and used with a national ID, a prepaid card, or a mobile phone or token, for example. In one or more embodiments, enrollment may require an existing relationship whereby the account is funded from another account.

In one or more embodiments, a customer may use the account at least for retail payments, storing value, cash in/cash out (CICO) services, transactional receipts (on cash and digital transactions), and as an inter-operable connection to other payment providers and accounts, and as a connection to non-bank payers/payees such as government and NGOs. In one or more embodiments, merchants may use the account at least for digital payment acceptance, storing value, and to receive transaction receipts (e.g., on cash and digital transactions). Inventory control services, merchandise discounts and personal spending history may be offered to the merchant/token holder as incentives to use the system and methods.

One or more embodiments may:

generate receipts for all transactions (e.g., both paper and electronic transactions);

provide for transactions to be settled immediately in good funds (e.g., no credit extension is provided);

provide for all transactions to occur in a Processor-On Us Environment (e.g. a pre-paid processor that is closed loop and houses the ledger accounts for all BoP Pay users on one platform. The fiduciary bank may house the funds reflected on the ledger accounts on the BoP Pay platform, as further described below). Conventionally, four-party business models are typically “processor off us” in that the processor of the merchant/acquirer may not also be the processor of the consumer/issuer. The three-party models may typically be processor-on-us with the network owner acting as both the acquirer/processor for the seller/merchant and the issuer/processor for the consumer. One or more embodiments may eliminate acquiring and delegate issuing to simple fiduciary roles, not necessarily requiring a bank to actually distribute the token;

operate regardless of utility status (electricity or telecommunications);

enable small, frequent digital transactions in a cash-like environment, guaranteeing good funds at all times;

empower consumers to track their spending and transactions;

generate valuable data for merchants, governments and NGOs by capturing cash transactions digitally;

enable lower cost service delivery (access);

allow banks and other legacy payment providers to leverage BoP Pay as a distribution means for services (e.g., credit, money transfer, etc.) that may otherwise typically require a standard banking relationship;

provide governments and NGOs with a connection to the payments system and create a platform for new innovators;

allow for the deactivation of cards based on proof of life or ID expiration per the issuer of the card or a government agency;

provide proof of life transactions, PIN change/reset and cash out as valid online transactions;

provide summary and detailed reports of transactions performed at Issuer Point Of Sale (POS) Terminals or a web-based or mobile interface may be used by agents and enrollment centers to conduct settlement and run settlement reports/summary for transactions performed at the POS or at agents. Financial settlement may be carried out by the Issuer;

provide support for transactions for cash with/without purchase and transactions authenticated at a terminal using biometrics;

provide integration with cloud based biometric databases (e.g., Aadhar in India)

provide connectivity as a payment bridge for government disbursements

provide for agents of one bank to service consumers of other banks, provided the consumer's bank is participating in BoP Pay. The agents may carry out all other such “off-us” transactions except account opening.

provide for one agent to service multiple banks, which may result in multiple settlement accounts in a bank. However, while providing services the agent will perform acquiring transactions for one particular bank and this bank will be responsible for settlement of those transactions. The agents may operate against funding limits and may have to maintain an account with the BoP Pay;

provide for an agent to open an account for consumers only in those banks with whom the agent is associated (e.g., correspondent relationship);

provide for one account per user;

provide for multiple modes of transaction (e.g., mobile application, USSD, SMS, MPTS agent portal or third party portals (e.g., a bank portal));

provide Application Programming Interfaces (API) for all transactions (financial and non-financial)

provide for transactions originating via API, where each external portal/application/interface may be treated as a separate network and limits may be configured network-wise;

provide only one device which may be used online as well as offline in an instance where multiple devices are associated with the consumer;

provide for offline amount limits to be configured on the chip profile associated with the token;

provide for online transactions against the online balance portion to be considered in the expiration of un-utilized loads. For example, if USD 100 was loaded on a token, out of which USD 80 was the online component, then the expired balance will be a maximum of USD 80, if it has not been spent;

provide for payments to be made to or received from other (not the BoP Pay account) open loop accounts, other Master Accounts or corresponding slave accounts. These transactions may be authorized online for the transaction to be valid. A slave account may provide a store of digital value units (DVU). The slave account may be a closed-loop instance of the stored value account that can pay DVUs to, or receive DVU payments from, other slave accounts only. The slave account may also download DVUs from, and upload DVUs to, the user's corresponding master Account. A slave account may only be associated with one master account. A master account may provide a store of funds linked to the issuing institution's cash deposits for the respective account. The master account may be an online instance of the stored value account that may receive funds from, or fund payments to, other master accounts and/or to home accounts. The master account may also download DVUs to the corresponding use's slave account and receive uploaded DVUs from the slave account. The master account may be funded by multiple home accounts, when applicable. A home account may be an account held at a fiduciary (i.e. A bank of mobile money provider). The home account may only be applicable when the master account is utilized as a pass-thru/gateway to access the slave account (presuming the user already has his/her own bank account (i.e., prepaid, mobile money or otherwise));

provide for slave accounts to move funds to another slave account in an offline manner without the need for an authorization;

provide for slave account transactions to not be repudiated by the originator or receiver for any reason.

In one or more embodiments, BoP Pay may support financial transactions (e.g., cash withdrawal, cash with (and without) purchase, load, cash deposits, purchase transaction(s), Remittance (e.g., MasterCard MoneySend), Remittance (e.g., P2P)), and non-financial transactions (e.g., proof of life, balance inquiry, PIN reset, PIN change). These transactions may be supported in both an online and offline mode. In one or more embodiments, the non-financial transactions, as well as cash out transactions may be supported on issuer terminals. In one or more embodiments, balance inquiry, cash-deposits, cash-out and P2P may be supported on Agent web or mobile interfaces. In one or more embodiments, digital value units (DVUs) may be the mechanism for off-line value exchange between slave accounts and may represent a “promise to pay” by the corresponding master account issuer. DVUs may be denominated in local currency, or other define value such as bags of rice, food aid points, etc. In one or more embodiments, proof of life may be supported on Agent mobile interfaces when a tablet with a finger-print reader device is connected. In one or more embodiments, balance inquiry, cash-out and P2P may be consumer initiated and may be supported on consumer-facing mobile applications. In one more embodiments, the mode of authentication may be biometric (e.g., for ATM/POS transactions), PIN based (e.g., for offline PIN authentication) or One Time Password (OTP).

In one or more embodiments, each biometric transaction within the system may be recorded as a valid proof of life transaction. As used herein, “proof of life” refers to the verification that a recipient is alive and who they say they are. A report may be made available to provide details of cardholders who have/have not completed a proof of life during the last ‘n’ days, where ‘n’ may be pre-defined (e.g., by a government). In one or more embodiments, advice messages and offline purchase transactions authenticated using biometric data may be treated as valid proof of life transactions. In one or more embodiments, enrollment center(s) and government agencies may be able to record proof of life manually. Manually recorded proof of life may be passed on in an offline mode to record proof of life transactions into the system using, for example, batch processing.

In one or more embodiments, an interface with an Interactive Voice Response (IVR) may be available for one or more consumer initiated transactions such as transaction history, current balance on card, retrieval of date for proof of life and PIN change.

In one or more embodiments, BoP Pay may allow a consumer to perform the following transactions without the use of an agent: balance inquiry, cash-out, P2P, transaction history (e.g., the last x transactions, where x is pre-defined), retrieval of date for proof of life, and PIN change.

In one or more embodiments, BoP Pay may generate transaction alerts and push the alerts to the mobile server of the Issuer for sending alerts via the contracted Telco operator.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

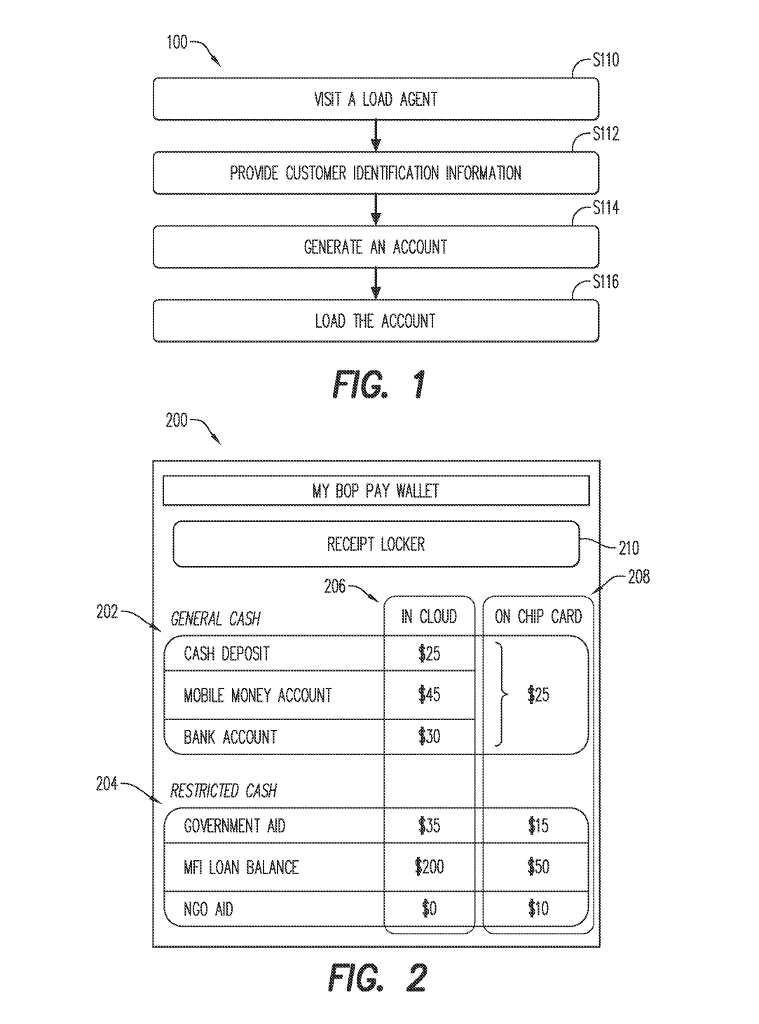

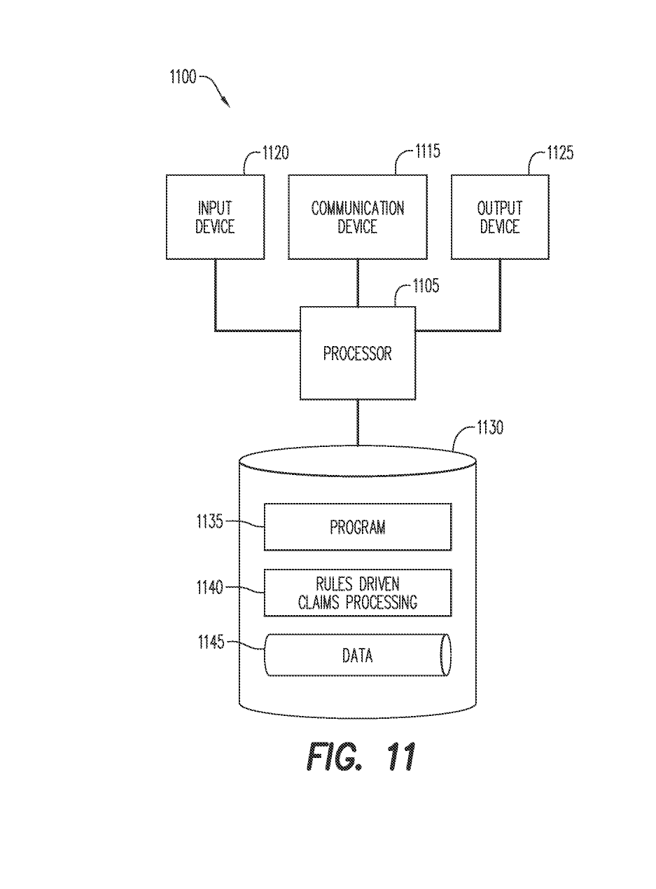

FIG. 1 is an illustrative depiction of a flow diagram for a process 100, in accordance with some embodiments of the present disclosure. Process 100 may provide an example flow of operations for a consumer or merchant to open a BoP Pay account (“account”). As used herein, the consumer and merchant will be collectively referred to as a user. Process 100 and other processes described herein may be performed using any suitable combination of hardware (e.g., circuit(s)), software or manual means. In one or more embodiments, the processor 1105 (FIG. 11) is conditioned to perform the process 100, such that the processor 1105 is a special purpose element configured to perform operations not performable by a general purpose computer or device. Software embodying these processes may be stored by any non-transitory tangible medium including a fixed disk, a floppy disk, a CD, a DVD, a Flash drive, or magnetic tape. Examples of these processes will be described below with respect to the elements of system 1100 (FIG. 11), but embodiments are not limited thereto.

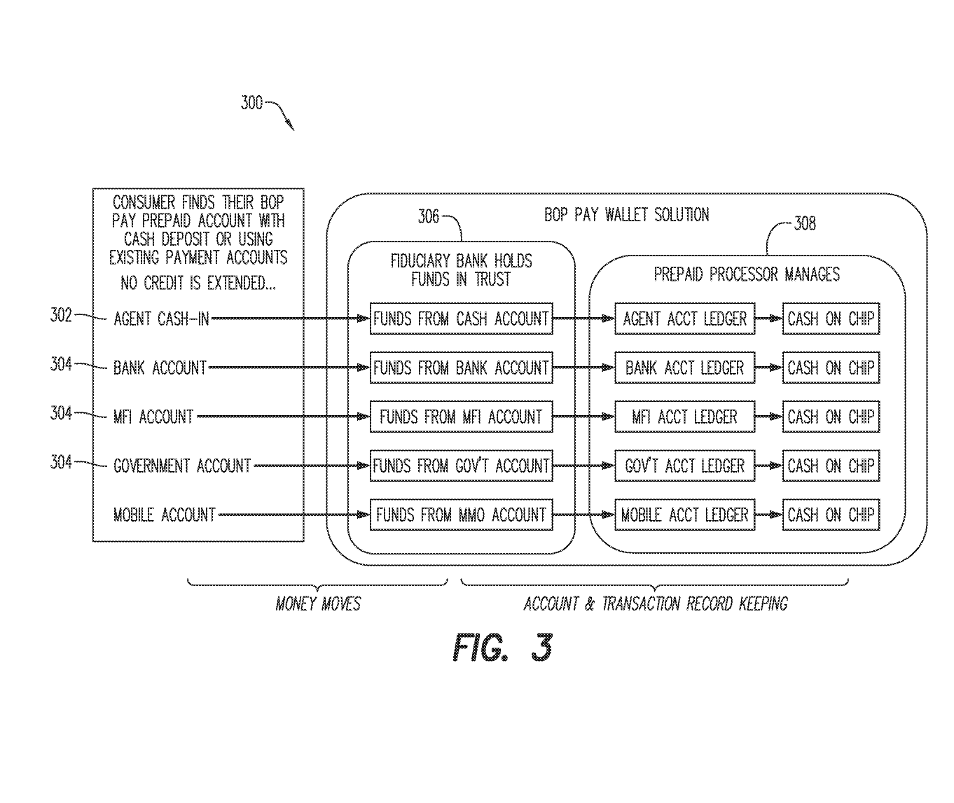

At S110, a user visits an agent to create the account. The user may visit the agent at a brick and mortar establishment, online, etc. In one or more embodiments, a web-based portal may be available for agents or issuing bank branches to service users and perform transactions (in addition to account creation) on their behalf. Then at S112, the user may provide customer identification (Know Your Customer or Customer Identification Program) information to the agent, such as their name. As conventionally known KYC are regulations used by banks to verify the identity of their clients. The KYC guidelines may differ by country. In one or more embodiments, lower levels of KYC compliance may result in lower Account and activity limits, and with more restrictive transaction type permissions. In one or more embodiments, in instances where agents open accounts for citizens (as opposed to the government), the account may not be active (i.e., allow money in or out) until the KYC is complete. In some instances, the KYC verification may occur via a mobile application integration with local biometric systems and in other instances, the KYC verification may result from a bank (or other entity) confirming the citizen's identification in a separate process. KYC verification may result from other suitable processes. In one or more embodiments, the user may register the account under a national ID and an EMV token (e.g., may be a card, phone or some other formal factor) or a personal phone number. The transactions may be EMV complaint in one or more embodiments. As used herein, an EMV (Europay, MasterCard and Visa) token is an integrated circuit (“chip”) embedded in a token for consummating a payment or data transfer transaction. The account is generated in S114. In one or more embodiments, the account may be generated by a wallet module, as will be further described below. Then in S116, the account is loaded. In some embodiments, for example, the account is loaded, via the wallet module, with cash and/or associated with a payment account, such as, but not limited to, a mobile money account, a bank account, a government account, a Microfinance institution (MFI) account. In one or more embodiments, the generated account may be referred to as a “wallet.” In one or more embodiments, a card may be issued with the set-up of the account. The card may be issued with a default PIN, which may be changed after issuance. The card may be activated at the time of issuance. After the cards are issued, the information about the cardholders may be provided to a processor 308 (FIG. 3) using an offline file. In one or more embodiments, a card may be deactivated/permanently blocked by use of an input file from an Institution (e.g., government agency). In one or more embodiments, a physical card may not be issued, and consumers may perform transactions in either an “agent-assisted” manner (e.g., where the agent uses a mobile device and/or web interface) and/or in a self-serve manner using a mobile interface. While many of the exemplary transactions described herein are in terms of card transactions, these transactions may be executed with a mobile interface, unless otherwise noted.

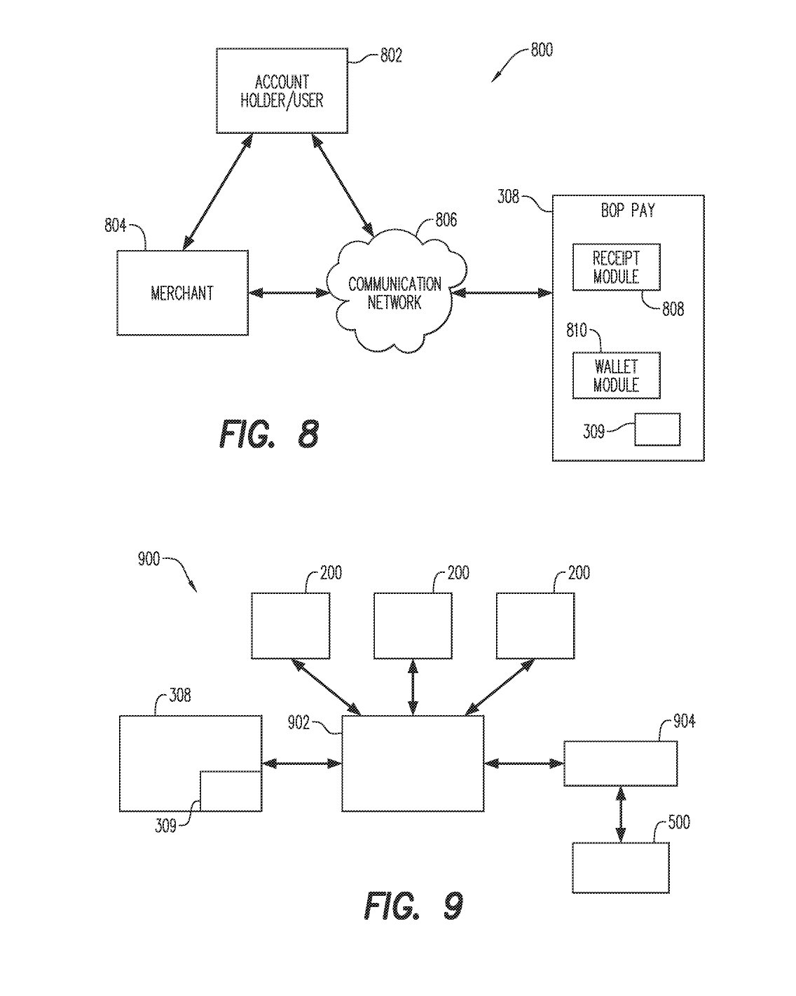

FIG. 2 is a display of the wallet 200 generated by the wallet module 810 (FIG. 8). As shown herein, the wallet 200 may include several accounts associated with funds. In one or more embodiments the accounts may be general cash accounts 202 (e.g., cash deposits, mobile money accounts, bank accounts) or restricted cash accounts 204 (e.g., government aid, MFI loan balances, NGO aid). In one or more embodiments, money associated with general cash accounts 202 may be used to purchase any products, while money associated with restricted cash accounts 204 may be used to purchase only certain products. In one or more embodiments, the money associated with each account may categorized as “in cloud” 206 or “on chip card” 208. In one or more embodiments, the “in cloud” category 206 refers to all of the money in the specific account or wallet, while the “on chip card” category 208 refers to the money stored on an Integrated Circuit token (e.g., IC cards or “chip cards”), referred to herein as a Wallet Chip Card 502 or “token” 502 (FIG. 5A). In some embodiments, the user designates the total amount of money stored on the token 502, and the amount of money from each account on the BoP Pay “cloud” that equals the total amount of money on the BoP Pay ledger.

In one or more embodiments, with respect to the restricted cash accounts 204, for government benefits added to the account, the account may be loaded in an offline/batch mode (e.g., automated processing) using files provided by government agencies. With regard to the restricted cash accounts, any load transaction (e.g., government or otherwise) may be future dated. In one or more embodiments, to future date a transaction, the load file used to add the funds to the user's account may provide account details, load information and a date when the load will be effective. The load amount may be processed as normal (e.g., not as an exception) in the batch. However, the load amount will be reflected in the user's account on a future date. In one or more embodiments, the government agency may also establish a recurring load whereby a load is repeated. In terms of the recurring load, the government agency may provide a load file to the processor 308 with cardholder information, load amount, frequency of the load transaction and a start date. The load may be effective on the start date and may be repeated at the predefined frequency until the recurring load is cancelled. In one or more embodiments, the load transaction may have a benefit type associated therewith, since each type of benefit may have a different expiration period or be subject to other terms.

In one or more embodiments, individual load transactions (e.g., a transaction to place funds/benefits on a token) may be tagged/dated. In some embodiments, the individual load transaction may expire if not utilized by a pre-defined date. In some embodiments, the funds may be used on a “first come first serve” manner. For example, on a purchase or withdrawal transaction, the funds may be taken from the earliest load still valid.

In one or more embodiments, the wallet 200 may include a receipt locker 210 generated by a receipt module 808 (FIG. 8). In one or more embodiments, a transaction receipt is created at every transaction—with or without electronic payments. In one or more embodiments, the user may review the receipts only via a connected device, as will be described further below.

FIG. 3 is a block diagram of a system 300 that includes illustrative devices that may be utilized for funding the wallet 200 via the wallet module 810. In some embodiments, the system 300 may be used to implement aspects of process 100, including S116. System 300 shows one or more existing cash accounts 302 or payment accounts 304. In one or more embodiments, the consumer funds their wallet 200 with cash deposits 302 or existing payment accounts 304, such that no credit is extended with the system. In one or more embodiments, to allow the funds to be accessed from the wallet 200, the funds from the cash account 302 or payment account 304 are first moved into a fiduciary bank 306, for example, which holds the funds in trust. Then, a processor 308 (e.g., MasterCard®) providing the wallet 200 manages the accounts, and is responsible for transaction record keeping (e.g., operation of the wallet module). For example, in one or more embodiments, the user may contact the processor 308 to move the money from a cash account and a bank account to the token 502 such that the money is available irrespective of the connectivity status. The processor 308 may keep a record of these transactions via the receipt module.

In one or more embodiments, deposited money is moved to the fiduciary 306. Then the user may retain that money at the fiduciary (“cloud” balance) or further transfer it to the token 502 (electronic cash). Transactions done in a disconnected (offline) environment may only be done with electronic cash loaded on the token 502. In one or more embodiments, funds on the token 502 may be treated as spent and may not be available for online/Card Not Present (CNP) transactions to ensure that the balances do not get “out of sync.” Connected (online) transactions may be done with token 502 contents and the “cloud” balance. In one or more embodiments, the amount of money in the fiduciary account may reflect what is in the cloud and on the token 502. Money may be loaded into the cloud through a connected account or at a load agent, in one or more embodiments. As used herein, money and benefits may be used interchangeably unless otherwise indicated. In some embodiments, money may be moved to the token 502 from the cloud, and may be loaded directly to the token 502 at a load agent, or transferred from a P2P transfer from another user's token 502. For example, money may have been transferred to the token 502 after a transaction, and instead of leaving the money on the token 502, the user may transfer the money to one of their other accounts. As described above, the cash on the token 502 is fiat currency such that if the wallet chip card is lost, the cash on the wallet chip card is also lost. However, if the card is found by someone else, the cash may be used depending on whether an identity authentication (e.g., personal identification number) element has been implemented and passed, otherwise the cash on the token may not be accessed. In the case of a lost (or damaged, or stolen) card, the card may be replaced and once the information is processed, the balances may be transferred, the previous card may be inactivated and the new card may be activated. In one or more embodiments, the lost/damaged/stolen card may be blocked in real-time. In one or more embodiments, authentication of the account holder may be via on-card biometric information, PIN, a biometric device connected to an agent tablet (leveraging a biometric database in the cloud), or a one-time password (OTP). In one or more embodiments, the PIN may be supported in both an online and offline mode. In one or more embodiments, for enrollment center or agent-based transactions, authentication may be OTP, biometric/PIN based or manual using government accepted identification cards. In an offline closed loop environment, authentication may be via PIN, No-PIN (no authentication) required and biometric. In one or more embodiments, authentication type may be based on the physical point of interaction. For example, at a POS terminal, the authentication options may be biometric, online PIN, and offline PIN; at an ATM terminal the authentication option may be an Online PIN; at an Enrollment Center, the authentication option may be biometric, Online PIN, Offline PIN and Manual, at an agent location with a card, the authentication options may be biometric, Online PIN, Offline PIN, and Manual; at an agent location with no card, but with a Tablet, the authentication options may be a OTP, a cloud-based biometric and MauI; and at a Customer mobile device, the authentication options may be a two-factor authentication (e.g., two methods of authenticating the transaction), or a OTP. As used herein, a two-factor authentication may involve two out of three of the following: 1. Prove you possess something (e.g., a key or a chip card); 2. Prove you know something (e.g., a PIN or a password); 3. Have a biometric verified. For example, the use of a chip and a PIN may be 2-factor authentication as entry of the PIN may cause the chip to release a cryptogram. A valid cryptogram may demonstrate possession of a unique chip card and the release of the cryptogram may demonstrate the user knew the PIN. As such, two factors have been exercised—possession of a particular unique chip card and knowledge of a PIN.

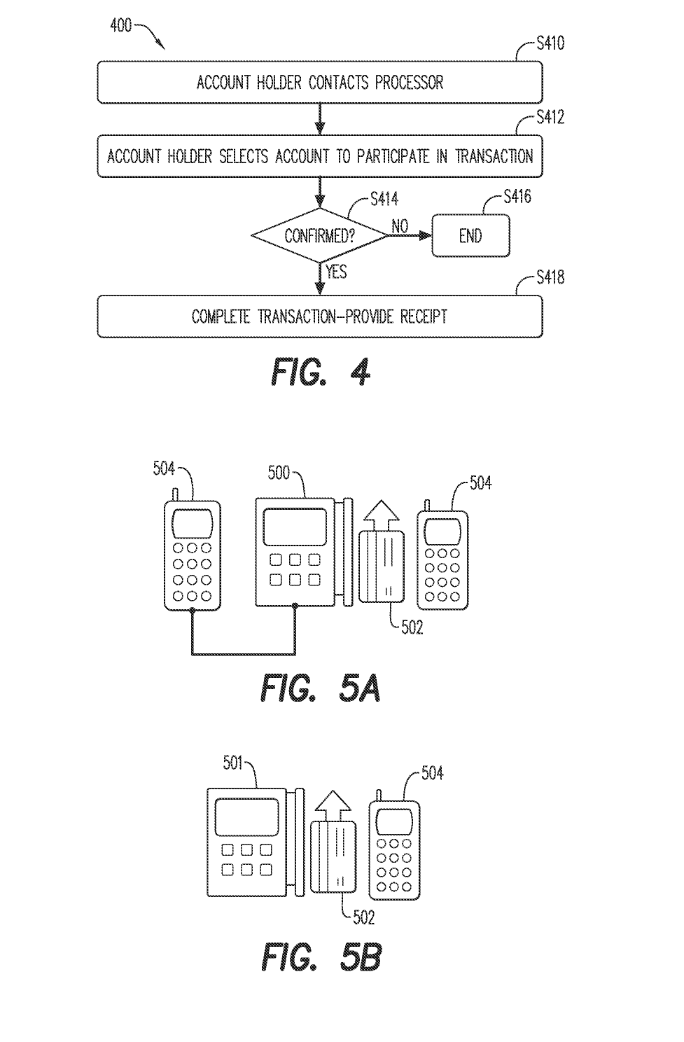

Turning to FIGS. 4 and 5A-B, in one example of operation according to some embodiments, FIG. 4 is a flow diagram of a process 400 for using the account. In S410, the user (token holder) contacts the wallet account provider (e.g., processor 308) to initiate a transaction (e.g., make a purchase or send funds P2P, or receive funds). Then in S412, the user selects the account to participate in the transaction (e.g., draw the funds from, or deposit the fund to). A decision is made whether to confirm the transaction amount in S414. If the transaction amount is not confirmed, the process ends in S416. If the transaction amount is confirmed, the funds are transferred to the appropriate accounts via the wallet module 810 and a receipt of the transaction is provided via the receipt module 808 in S418 to the receipt locker 210.

For example, in one or more embodiments, a user may transfer funds in a P2P transaction, or may transfer funds to a distant merchant or utility as an electronic transaction/electronic payment.

In one or more embodiments, for example, as shown in FIGS. 5A and 5B, when the merchant is connected to a communication network (e.g., Internet), and using a Mobile Point of Sale (M-PoS) token terminal device 500 (FIG. 5A) or a PoS token terminal device 501, the user may access his accounts by dipping/swiping the token 502 through the token terminal device 500/501 or by using their token 502 via their Mobile device 504. In some embodiments, the money in the cloud category 206 may only be accessible when the token terminal device 500 is connected to the network or when the mobile device 504 and the merchant are connected via a mobile application, for example. As used herein, a mobile application is a computer program designed to run on smartphones, tablet computers and other mobile devices. When the token terminal device 500/501 is connected to the network, it may connect to a central server 902 (FIG. 9) at the processor 308. In one or more embodiments, the processor 308, or processing platform (e.g., PTS) 309 associated therewith, will communicate with the central server 902 (e.g., Mondex server) via an Application Program Interface (API) with cash-in/cash-out (CICO) instructions akin to instructing an automatic teller machine (ATM). As used herein “processor” and “processing platform” may be used interchangeably unless otherwise noted. The wallet module 810 at the processor 308 may then credit and debit the accounts per the transaction, and update the token 502 accordingly.

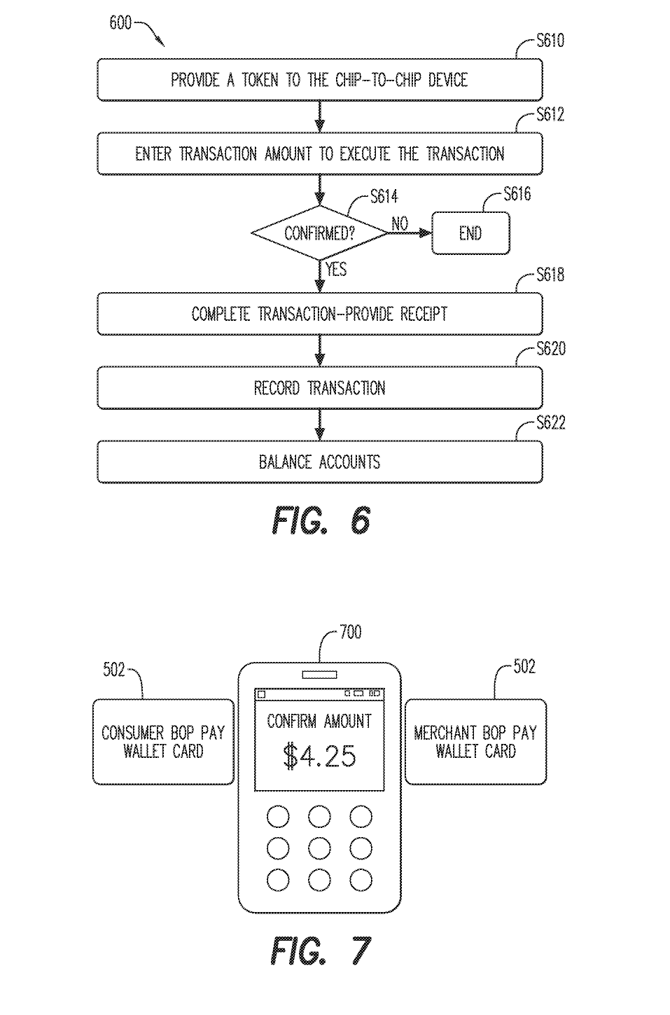

Turning to FIGS. 6 and 7, in one example of operation according to some embodiments, FIG. 6 is a flow diagram of a process 600 for using the account. In one or more embodiments, the money in the cash category 204 may be accessible regardless of whether the merchant is connected or disconnected to/from the network (e.g., where no M-PoS/PoS is present) by using a chip-to-chip device 700 (FIG. 7). The chip-to-chip device 700 may be selectively online or offline. The chip-to-chip device/reader 700 may provide communication between two tokens 502 in an offline environment. The token 502 may transact with other tokens via the chip-to-chip device/reader 700 in an offline environment. Regardless of online or offline connectivity, the transaction occurs in real-time. In S610 the consumer and the merchant each provide a token 502 to the chip-to-chip device 700. In one or more embodiments, the tokens 502 may be inserted into the chip-to-chip device 700 and remain therein for the length of the transaction, or the tokens 502 may be positioned close enough to the chip-to-chip device 700 to allow the transaction to occur. In one or more embodiments if either of the tokens 502 is moved out of a pre-defined distance from the chip-to-chip device 700, the transaction may end after a predetermined amount of time. Then in S612, a transaction amount is entered into the chip-to-chip device 700 to execute the transaction. A decision is made whether to confirm the transaction amount in S614. In one or more embodiments, the processing platform 309 may provide gateway/authorization services. In one or more embodiments, the processing platform 309 may perform transaction authorization and may provide transaction data to perform clearing and settlement functions for agents using POS terminals. In one or more embodiments, the POS terminals may be provided by the Issuer of the card program or by an Acquirer for those agents. If the transaction amount is not confirmed, the process ends in S616. If the transaction amount is confirmed, the transaction is executed and the funds are transferred from one token to the other token in real-time, and a receipt of the transaction is provided in S618 to the receipt locker 210 via the receipt module 808. The local transaction is stored/recorded on each of the tokens in S620. When either of the tokens is next connected to the network, ledger updates and receipts including the details of the transaction can be updated/balanced for each account via the wallet module 810 and receipt module 808 in S622. It is noted that only one token connecting to the network is needed to update both accounts via the wallet module 810 and receipt module 808. In one or more embodiments, the wallet module 810 and receipt module 808 include an identifier that recognizes an account has already been updated per a particular transaction such that the connection of each of the tokens does not duplicate transactions for the accounts.

In one or more embodiments, the M-PoS, PoS devices 500/501 and the chip-to-chip device 700 may:

enable funds to move from one off-line account to another off-line account;

enable funds to move from an off-line (slave) account to its online (Master) account;

report back to a data storage facility (i.e., platform) the current transaction as well as all slave account transaction history since the last time the slave account went online;

record cash-based transactions;

support internal merchant operations (e.g., inventory control, cash flow analysis, etc.); and

support value added services (e.g., top-up (buying additional airtime), cash-in (depositing money into your account), bill payment, etc.) that enable a merchant/agent to derive revenues beyond the normal operations of the store.

In one or more embodiments, the M-PoS, PoS devices 500/501, and chip-to-chip device 700 may also be used in a cash transaction, where the consumer is not paying for merchandise using a token, but instead is using physical currency, and a receipt for the transaction is desired.

When using the chip-to-chip device 700 for a cash transaction, similarly to the process 600 described above, S610 is performed. Then a “receipt only” button may be selected, for example, and the basic transaction details are then logged onto the token 502. The receipt is stored on each of the tokens. When either of the tokens is next connected to the network, the receipts including the details of the transaction can be updated and stored in the receipt locker 210 for each account via receipt module.

Similarly, if the M-PoS or PoS 500/501 device is not connected to the network, for a cash transaction, a “receipt only” button may be selected, for example, and the basic transaction details are then logged onto the token 502 and the M-PoS or PoS 500/501 device. The receipt is stored on each of the token and device. When either of the token or device is next connected to the network, the receipts including the details of the transaction may be updated and stored in the receipt locker 210 for each account via the receipt module.

When using the connected M-PoS or PoS devices 500/501, for a cash transaction, the token 502 is inserted or dipped in the device 500/501, and a “receipt only” button may be selected. As the terminal is connected, the receipt is uploaded to the receipt locker 210 for each token as it is created for the transaction in real-time.

FIG. 8 is a block diagram of a system 800 that includes illustrative devices and systems that may be utilized for creating a wallet 200 and using the wallet via the token 502, for example. In some embodiments, system 800 may be used to implement aspects of processes 400 and 600. System 800 shows an account holder (consumer/user) at 802.

Account holder 802 may communicate with merchant 804 directly (e.g., via chip-to-chip device 700) or via the processor (“BoP Pay”) 308, and/or with BoP Pay 308 directly, depending on the task or process they wish to undertake. For example, account holder 802 may interact with merchant 804 in an effort to conduct a payment transaction using the token 502 as a means of payment. As in some other embodiments, the merchant may be a retail location, an online presence, a remittance processor, an individual, and other entities equipped to accept the token 502 as a form of payment. In another example, account holder 804 may interact with the processor 308 in an effort to view, update or change their account information (e.g., edit accounts, move money, review accounts and/or receipts etc.).

In some embodiments, authorization of a payment transaction using a token 502 may be processed in a conventional manner, including exchanges of information related to the payment transaction between merchant 804 and the processor 308. As illustrated, authorization and settlement of the payment transaction may be facilitated by communication network 806. In one or more embodiments, in a disconnected (offline) transaction, there is immediate settlement in that funds are moved from one token to another. In one or more embodiments, where there is connectivity (online) and the merchant is desiring the funds removed from the consumer's token or their “cloud” balance to be sent to the merchant's account there is settlement. As used herein, the settlement is akin to record keeping in that all funds and accounts are held within one closed system.

In one or more embodiments, while there may be no repudiation or chargebacks, there may be administrative reversals. For example, a consumer and merchant may not request a reversal based upon faulty service or goods not as advertised. However, if the processor 308 makes a mistake, and credit/debits parties inaccurately, then a reversal of that credit/debit may be facilitated.

In the instance of account holder 802 interacting with BoP Pay processor 308 in an effort to, for example, update or change their account information, communication and exchanges of information may be transmitted via the communication network 806. In some embodiments, the communication network 806 may be a public network such as the Internet, while in other embodiments at least portions of the communication network 812 may include a private network.

In some aspects, the communication and exchange of information from merchant 804 to account holder 802 may be accomplished via the communication network 806. In some other instances, a communication from merchant 804 to account holder 802 may be accomplished via a direct wireless communication such as, for example NFC (near field communication) or RF (radio frequency) communication protocols. As an example of some communication exchanges herein, account holder 802 may communicate a wallet/account to be used in a payment transaction to a proximity reader POS device at merchant 804 via a NFC equipped smartphone or other computing device, whether portable and/or including mobile telephony functionality or otherwise. Upon receipt of the wallet/account and confirmation of the transaction, the BoP Pay processor 308 may commence movement of the funds via the wallet module 810. In some embodiments, the network communication 806 (e.g., Internet) with the BoP Pay processor 308 may be facilitated by a wifi “hotspot” maintained by merchant 804 at or in the vicinity of their retail location(s).

FIG. 9 is a block diagram of a system 900 that includes illustrative devices and systems that may be utilized for offline/cash-like transactions using the processor 308 (“BoP Pay processor”) via the token 502, for example. In some embodiments, system 900 may be used to implement aspects of processes 100, 400 and 600. System 900 includes, one or more MPOS devices 500 (e.g., “Miura” MPOS device), the processor 308, a central server 902, one or more chip readers 700 and an online terminal 904 (e.g., “Android tablet” terminal).

As described above with respect to FIGS. 4-8, the processor 308 (e.g., PTS) may communicate with the central server 902 (e.g., Mondex server) via an API with CICO instructions similar to instructing an ATM. The central server 902 may communicate with the processor 308 and the MPOS devices 500 and terminals 904. The MPOS device 500 may communicate with the terminal 904 via any suitable manner (e.g., Bluetooth, USB, etc.), which, in turn, may communicate with the central server 902 and tokens 502. The token 502 may also be read by MPOS devices 500 and terminals 904 in offline and online environments, which, in turn, communicate transaction data back to the central server 902 when the MPOS/terminal is online.

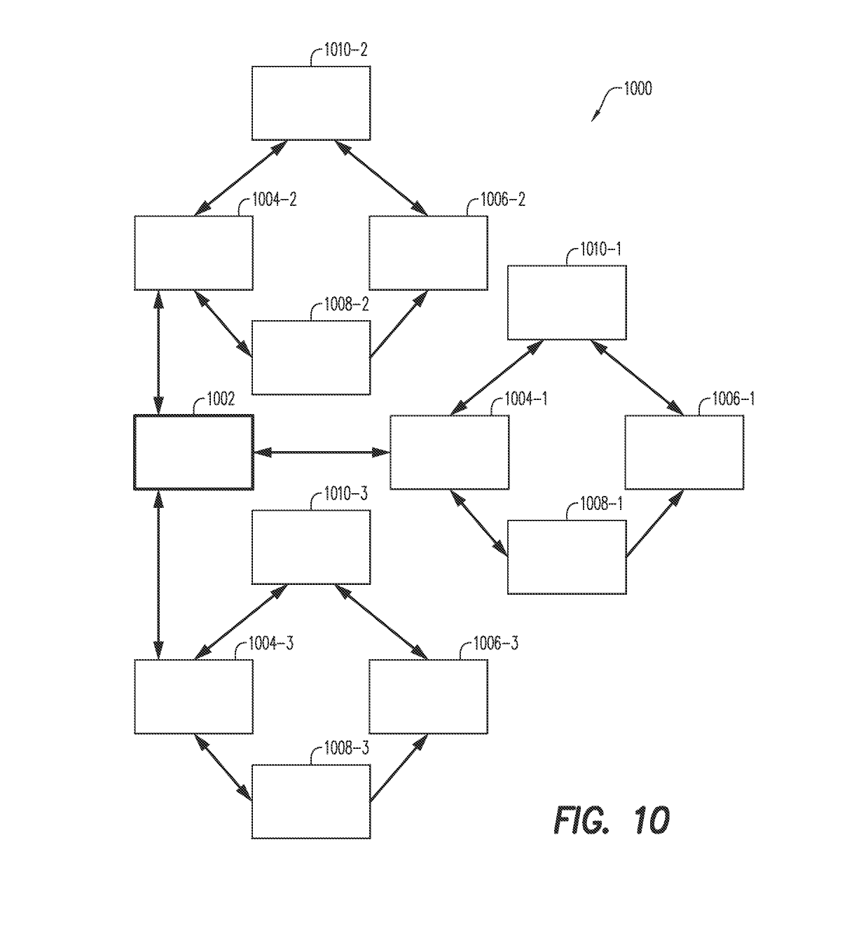

A non-limiting example of use of the system 900 is as follows. The processor 308 via the processing platform 309 instructs the central server 902 via API that the server should deploy $1M of value into an ecosystem associated with the server 902. The processor 308 also informs the central server 902 of the breakdown of how the monies are distributed across all of the wallets 200 and/or tokens 502 in the ecosystem. The server 902 then allocates the funds according to the breakdown. When a consumer with one of the tokens 502 in the ecosystem goes online via the MPOS device 500/terminal 904, the MPOS device 500/terminal 904 receives instructions from the central server 902 that this token (e.g., token A) now has $20 allocated to it, and the terminal 904 updates the token accordingly. This $20 token 502 now transacts offline with another token via the chip reader 700, for example. The chip reader 700 moves $10 from one token to the other token. In one or more embodiments, offline transactions may continue to be made within the ecosystem along with logging of data until capacity of the token has been exhausted and no new transactions may be logged or the oldest record may be deleted and replaced with a new logged entry. Token A the goes back online via MPOS device 500/terminal 904, and MPOS device 500/terminal 904 mediates this cash out transaction data and enables deposit back to the server 902 of the wallet 200 associated with token B. The server 902 may communicate this transaction detail back to the processor 308 via the API. The processor 308 may update a master account ledger (or online slave account and then master account) with transaction data, as further described below with respect to FIG. 10. With respect to the transaction described above, each token 502 may record the transaction as follows: The sending token (token A) records a cash out of $10 to the receiving token (token B), and token B records a cash in of $10 from token A. In one or more embodiments, a date/time stamp may be provided by the token, and/or may be captured by the terminal 501. In one or more embodiments, the token 502 may capture other bits of information (e.g., descriptions and/or quantities of items purchased, other information as required by regulatory bodies, NGOs or other program managers, or any other suitable data).

FIG. 10 is a block diagram of a system 1000 that includes illustrative devices and systems that may be utilized for offline/cash-like transactions using the processor 308 (“BoP Pay”) via the token 502, for example. In some embodiments, system 1000 may be used to implement aspects of processes 100, 400 and 600. System 1000 includes a home account 1002, a master account 1004, an online slave account 1006 (i.e., an account in a cloud), an offline slave account on a chip 1008 (e.g., a device; card and mobile phone), an account holder (consumer/user) 1010, and one or more devices 1012. As used herein, the offline slave account on a chip 1008 corresponds to the token 502 described in other embodiments.

In one or more embodiments, the home account 1002 is an open loop account (e.g., mobile money; GBS prepaid; pooled account setup at a designated bank for purposes of disbursements; other bank account) that may provide funding to the closed loop master account 1004. In one or more embodiments, the master account 1004 may be online (i.e., an account in a cloud). In one or more embodiments, the master account 1004 and online slave account 1006 may be tied to the same account holder 1010 and offline slave account 1008. Funds may move bi-directionally between the master account 1004 and the online slave account 1006. In one or more embodiments, transactions may be captured by the offline slave account 1008. In one or more embodiments, the online slave account 1006 and the offline slave-chip account 1008 balance and transaction entries (from offline to online) may be synched when the offline slave chip 1008 goes online. In one or more embodiments, when synching takes place between the online slave account 1006 and the offline slave account 1008, the online slave account 1006 will then synch with the master account 1004. When synching does not take place between the online slave account 1006 and the offline slave account 1008, the offline slave account 1008 will synch directly with the master account 1004. In some embodiments, only transaction entries (not balances) on the offline slave chip 1008 may be cleaned/removed once synching is complete. In one or more embodiments, balances may remain on the offline slave chip 1008, and may be synched in both online slave accounts 1006 and offline slave accounts 1008.

In one or more embodiments, when an online slave account 1006 is employed, to avoid synching issues, communication between online slave account 1006 and offline slave account 1008 may be unidirectional. The offline slave account 1008 may send balance and general ledger entry data to the online slave account 1006, but nothing may flow from the online slave account 1006 to the offline slave account 1008. Additionally, the master account 1004 may only communicate with the offline slave account 1008, and not the online slave account 1006. The communication between the master account 1004 and the offline slave account 1008 may be bidirectional for the purpose of moving funds from the master account 1004 to the offline slave account or back. In some embodiments, balance and general ledger entries may not be communicated between the offline slave account 1008 and the master account 1004.

A non-limiting example of use of the system 1000 is as follows. An NGO (non-governmental organization) sets up and funds $1000 to a pooled Home Account 1002 at a designated bank. As used herein a “pooled home account” is a single bank account that holds all customers' deposits belonging to a card program. The NGO may provide a batch file to a bank processor (e.g., Payment Transaction Services (PTS) (MasterCard wholly owned payments processor)) with funding instructions for all master accounts 1004 associated with the pooled home account 1002. For example, the pooled home account 1002 may represent ten (10) master accounts 1004. Other suitable numbers of master accounts may be associated with the home account. The funding instructions provide for each master account to be credited with $100. Other suitable instructions may be provided. Then the processor funds each master account 1004 with $100. A first master account 1004-1 funds a corresponding offline slave account 1008-1 with $50, resulting in the ledger associated with master account 1004-1 showing $50 remaining in the master account 1004-1, and $50 given to the offline slave account 1008-1. When the corresponding offline slave account 1008-1 goes online, it may be synched with the online slave account 1006-1, and then the online slave account 1006-1 also shows a balance of $50. In one or more embodiments, the online slave account 1006-1 may be a cloud representation of the offline slave account 1008-1, which may have an optional synch process. The offline slave account 1008-1 may go offline and transact with a second offline slave account 1008-2 (e.g., a slave account associated with a second master account different from the first master account). The first offline slave account 1008-1 sends $20 to the second offline slave account 1008-2, using the process 400 and 600 described above with respect to FIGS. 4-7, for example. The first offline slave account 1008-1 records a debit of $20 with a remaining Open To Buy (“OTB”) (e.g., funds available to be used) of $30. The second offline slave account 1008-2 records a credit of $20 with an OTB of $20, assuming that the balance on the second offline slave account 1008-2 was $0 prior to the transaction. In one or more embodiments, the transactions on the first offline slave account 1008-1 and the second offline slave account 1008-2 may be recorded at one of the same time, approximately the same time, and at different times. The first offline slave account 1008-1 may now conduct an offline Cash-Out $10 transaction with a third offline slave account 1008-3. Then the first offline chip account 1008-1 records a debit of $10 cash out, with a new OTB of $20, and the third offline chip account 1008-3 records a credit of $10 with an OTB of $10, assuming that the third offline chip account 1008-3 was previously at $0 balance. Then the first offline chip account 1008-1 connects to an online terminal 904 and the terminal reports back to the online slave account 1006-1 (or to the master account 1004-1, if the online slave account 1006-1 is not employed, to keep costs down, for example) the complete transaction history (assuming the transaction history was recorded), and the new balance of the first offline slave account 1008-1 since going offline. The first offline slave account 1008-1 transaction history may then be removed from the token, while the balance is maintained. In one or more embodiments, both the transaction history and balance are maintained.

FIG. 11 is a block diagram overview of a wallet and receipt processing system, apparatus or platform 1100 according to some embodiments. System 1100 may be, for example, associated with any of the processes described herein, including for example a device or system to implement aspects of processes 100, 400 and 600. System 1100 may include an application server supporting a BoP service. System 1100 comprises a processor 1105, such as one or more commercially available Central Processing Units (CPUs) in the form of one-chip microprocessors or a multi-core processor, coupled to a communication device 1115 configured to communicate via a communication network (e.g., communication network 812) to another device or system, or with one or more users. In the instance system 1100 comprises an application server, communication device 1115 may provide a means for system 1100 to interface with a client device (e.g., a merchant POS device/token). The system 1100 further includes an input device 1120 (e.g., a touch screen, mobile point of sale device, key pad, mouse and/or keyboard to enter content) and an output device 1125 (e.g., a computer monitor, touch screen, key pad, mobile point of sale device to display a user interface element).

Processor 1105 communicates with a memory/storage device 1130. Storage device 1130 may comprise any appropriate information storage device, including combinations of magnetic storage devices (e.g., a hard disk drive), optical storage devices, and/or semiconductor memory devices. In some embodiments, storage device may comprise a database system.

Storage device 1130 stores program code 1135 and/or wallet and receipt module processing logic 1140 that may provide computer executable instructions for controlling the processor 1105 (e.g., processing requests from, for example, client devices in accordance with processes herein). Processor 1105 may perform the instructions of the programs 1135/1140 to thereby operate in accordance with any of the embodiments described herein. For example, the processor 1105 may receive a transaction and then may apply the wallet module and receipt module to effect the transaction in both the consumer and merchants accounts, and provide a receipt to each. Program code 1135 may be stored in a compressed, uncompiled and/or encrypted format. Program code 1135 may furthermore include other program elements, such as an operating system, a database management system, and/or device drivers used by the processor 1105 to interface with, for example, peripheral devices. Storage device 1130 may also include data 1145. Data 1145 may be used by the system 1100 to execute operations related to the BoP Pay processes disclosed herein. Data 1145 may be used by system 1100, in some aspects, in performing the processes herein, such as processes 100, 400 and 600. For example, a relational database table may be persisted or referenced by data 1145 that includes a directory or other data structure containing records of wallets 200 registered with the BoP Pay service.

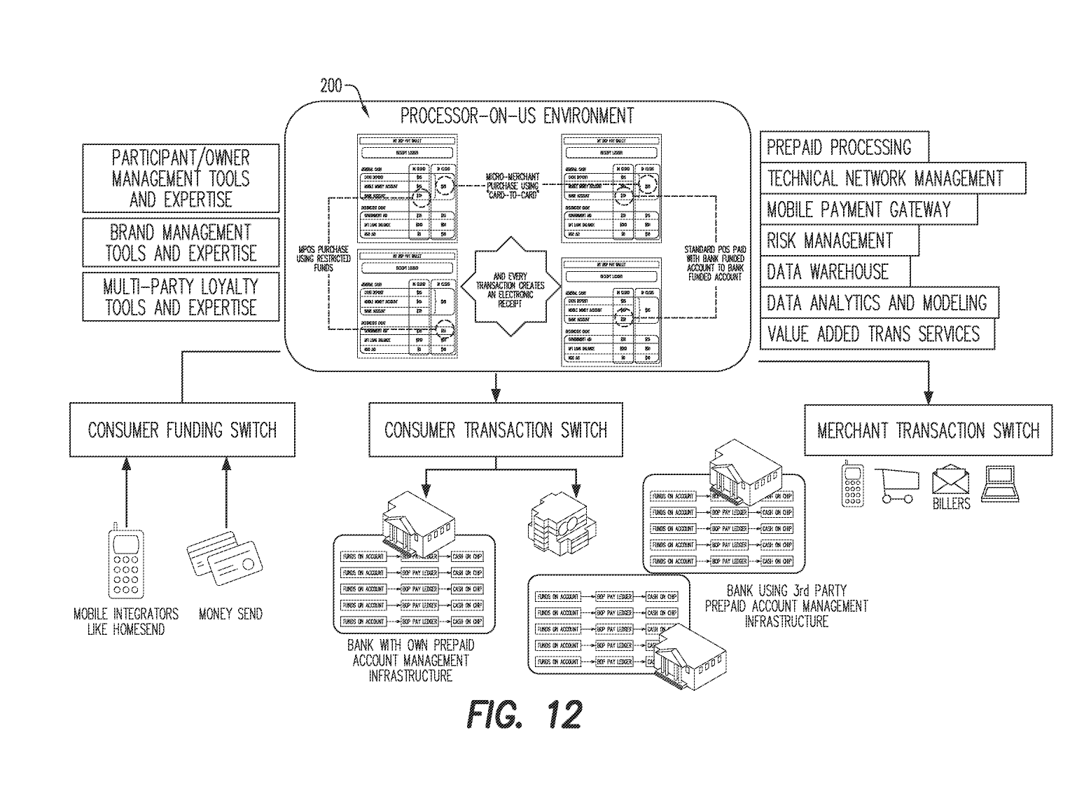

FIG. 12 is a block diagram of a system overview including the BoP Pay wallet 200, as well as services associated therewith. For example, data 1145 provided by the wallets 200 may be used to facilitate consumer funding endeavors (e.g., leveraging participant/owner management tools and expertise, brand management tools and expertise, multi-party loyalty tools and expertise); consumer transactions (e.g., development of banks with their own prepaid account management infrastructure, development of banks using 3^{rd} party prepaid account management infrastructure); and merchant transactions (e.g., prepaid processing, technical network management, mobile payment gateways, risk management, data warehouses, data analytics and modeling, value added Trans services). In one or more embodiments, the processor (e.g., MasterCard®) 308 may perform at least some of these services.

As used herein, information may be “received” by or “transmitted” to, for example: (i) the platform 1100 from another device; or (ii) a software application or module within the platform 1100 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a wallet module and a receipt module. The method steps can then be carried out using the distinct software modules and/or sub-modules of the system, as described above, executing on one or more hardware processors 1105 (FIG. 11). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
receiving at a device a first token associated with a first account;
executing a transaction;
recording the executed transaction at each of the device and the first token, wherein the execution of the transaction is offline; and
balancing the account associated with the first token per the transaction when the first token is online after the executed transaction.

2. The method of claim 1, wherein the transaction is executed in real-time.

3. The method of claim 1, further comprising:
receiving at the device a second token associated with a second account, wherein the transaction is executed between first token and the second token;
recording the executed transaction at the second token; and
balancing the account associated with the first token and the second token per the executed transaction when one of the first token and the second token are online after the executed transaction.

4. The method of claim 3, wherein the transaction is executed with funds stored on one of the first token and the second token.

5. The method of claim 3, further comprising:
associating an identifier with the first account and the second account, wherein the identifier recognizes the account has already been balanced per the transaction.

6. The method of claim 1, wherein the device is one of a chip-to-chip device, a mobile point of sale device or a point of sale device.

7. The method of claim 1, further comprising:
accessing one or more accounts associated with the first token via receipt at the device when the device is online; and
selecting the account to associate with the transaction.

8. The method of claim 1, further comprising:
generating a receipt of the executed transaction via a receipt module when the first token is online.

9. The method of claim 8, wherein the receipt includes the details of the executed transaction.

10. A system comprising:
a first token associated with a first account;
a device operative to receive the first token;
wherein a transaction between the first token and the device is executed and then recorded on each of the first token and the device;
a memory;
at least one bottom of pyramid pay processor, coupled to the memory, and operative to:
receive the transaction information, and
balance the account associated with the first token per the transaction when the first token is online after the executed transaction

11. The system of claim 10, wherein the device is selectively online and offline.

12. The system of claim 10, wherein the transaction is executed in real-time.

13. The system of claim 10, further comprising:
a second token associated with a second account, wherein the transaction is executed between first token and the second token;
wherein the bottom of pyramid pay processor is operative to:
record the executed transaction at the second token; and
balance the account associated with the first token and the second token per the executed transaction when one of the first token and the second token are online after the executed transaction.

14. The system of claim 13, wherein at least one of the first token and the second token store funds prior to the transaction, and the transaction is executed with the stored funds.

15. The system of claim 13, further comprising:
an identifier associated with the first account and the second account, wherein the identifier recognizes the account has already been balanced per the transaction.

16. The system of claim 10, wherein the device is one of a chip-to-chip device, a mobile point of sale device or a point of sale device.

17. The system of claim 10, further comprising:
a wallet module operative to:
access one or more accounts associated with the first token via receipt at the device when the device is online; and
select the account to associate with the transaction.

18. The system of claim 10, further comprising:
a receipt module operative to generate a receipt of the executed transaction when the first token is online.

19. The system of claim 18, wherein the receipt includes the details of the executed transaction.
